(19) United States
(12) Patent Application Publication
(10) Pub. No.: US 2005/0289591 A1
(43) Pub. Date: Dec. 29, 2005

(54) System and method for program guides

(76) Inventors: Larri Vermola, Turku (FI); Toni Paila, Degerby (FI); Harri Pekonen, Raisio (FI)

Correspondence Address: MORGAN & FINNEGAN, L.L.P., 3 WORLD FINANCIAL CENTER, NEW YORK, NY, 10281-2101, US

(21) Appl. No.: 10/878,856

(22) Filed: Jun. 28, 2004

(51) Int. Cl. G06F 3/00; G06F 13/00; H04N 5/445

(52) U.S. Cl. 725/45; 725/39

(57) ABSTRACT

Systems and methods applicable, for example, in the provision of Unified Program Guides. A provided Unified Program Guide might, for instance, be employed in learning about available programs, requesting programs, requesting program recording, initiating software, functionality, operation, and/or the like, and/or the like.

### FIELD OF INVENTION

This invention relates to systems and methods for program guides.

### BACKGROUND INFORMATION

In recent years, there has been an increase in the ways in which programs (e.g., audio programs and video programs) are delivered. For example, programs may be received via Amplitude Modulation (AM) radio, Frequency Modulation (FM) radio, satellite radio, satellite television, conventional television, and the Internet.

Accordingly, there may be interest in technologies that facilitate the use of such programs.

### SUMMARY OF THE INVENTION

According to various embodiments of the present invention there are provided systems and methods applicable, for example, in the provision of Unified Program Guides.

A provided Unified Program Guide might, for instance, be employed in learning about available programs, requesting programs, requesting program recording, initiating software, functionality, operation, and/or the like, and/or the like.

### BRIEF DESCRIPTION OF THE DRAWINGS

FIG. 1 shows exemplary steps involved in unified program guide setup according to various embodiments of the present invention.

FIG. 2 depicts an exemplary embodiment wherein there is hierarchy support.

FIG. 3 shows exemplary steps involved in unified program guide operation according to various embodiments of the present invention.

FIG. 4 shows an exemplary graphical user interface according to various embodiments of the present invention.

FIG. 5 shows an exemplary computer.

FIG. 6 shows a further exemplary computer.

### DETAILED DESCRIPTION OF THE INVENTION

General Operation

According to various embodiments of the present invention there are provided systems and methods applicable, for example, in the provision of Unified Program Guides (UPGs). Such a UPG might, for example, correspond to multiple bearers.

A provided UPG might, for instance, be employed in learning about available programs, requesting programs, requesting program recording, initiating software, functionality, operation, and/or the like, and/or the like. It is noted that, in various embodiments, multiple devices may be employed in the provision of a UPG.

Various aspects of the present invention will now be discussed in greater detail.

Unified Program Guide Setup

According to various embodiments of the present invention there are provided systems and methods applicable, for example, in the provision of unified program guides (UPGs) relating, for instance, to the program offerings of multiple bearers. It is noted that, in various embodiments, program guide information may be made available for medias, bearers, and/or the like for which built-in guides are not available. It is further noted that, in various embodiments, a program guide corresponding to only one bearer might be provided.

Such program offerings might, for instance, include audio programs, video programs, interactive programs, and/or the like. Such bearers might, for instance, include conventional television (e.g., broadcast and/or cable National Television Standards Committee (NTSC) television, Phase Alternating Line (PAL) television, and/or the like), digital cable television, satellite television, Frequency Modulation (FM) radio, Amplitude Modulation (AM) radio, subcarrier (e.g., FM subcarrier), Digital Audio Broadcasting (DAB), Digital Radio Mondial (DRM), satellite radio, Digital Video Broadcasting (DVB) (e.g., terrestrial digital video broadcast (DVB-T), Digital Video Broadcasting: Handhelds (DVB-H), Satellite Digital Video Broadcast (DVB-S), and/or the like), Advanced Television Systems Committee (ATSC), Integrated Services Digital Broadcasting (ISDB) (e.g., Terrestrial ISDB (ISDB-T)), Internet Protocol (IP), the Internet, General Packet Radio Service (GPRS), Universal Mobile Telecommunications Service (UMTS), Global System for Mobile Communications (GSM), Multimedia Broadcast and Multicast Service (MBMS), IEEE 802.11 (e.g., IEEE 802.11a, IEEE 802.11b, IEEE 802.11g, IEEE 802.11n, and/or the like), IEEE 802.16, Bluetooth, Ultra Wide Band (UWB), wireless Firewire, Ethernet, T1, and/or the like.

In various embodiments, devices such as, for example, servers, nodes and/or other computers (e.g., wired and/or wireless terminals), consumer devices (e.g., televisions, radios, set-top boxes, entertainment devices, consumer electronics devices, and/or the like), and/or the like might act in UPG provision. It is noted that, in various embodiments, a program (e.g., an interactive program) may involve the dispatch of data from a user's device. Such dispatch might, for instance, include votes, requests, answers, and/or the like. Such return might, for example, employ the same bearer used by the user's device to receive the program, a different bearer, and/or the like.

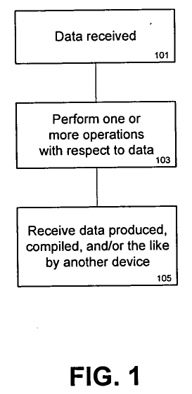

With respect to FIG. 1, it is noted that, according to various embodiments, received data may be employed in UPG provision (step 101). Such data might be received in a variety of ways, from a variety of sources, and/or the like. For instance, such data might be received via one or more bearers of the sort discussed above. As a specific example, data corresponding to programs available via FM radio might be made available via DVB (e.g., DVB-H), GPRS, and/or the like.

The, such data might, for example, be received along with programs (e.g., embedded in one or more program data streams), be received separately from programs, be received via the same bearer as one or more corresponding programs, be received via one or more different bearers than one or more corresponding programs, and/or the like.

The data might, in various embodiments, be pushed, pulled, broadcast, fetched, and/or the like, be received via established venues for receiving program guide information, be received via Simple Object Access Protocol (SOAP), Remote Method Invocation (RMI), Java Messaging Service (JMS), and/or the like, and/or the like.

A variety of information could be conveyed via the data. For example, the data could convey, with respect to various programs, metadata, titles, actors, directors, performers, genres, types, run times, start times, end times, schedules, service names, intended audiences (e.g., recommended age groups, age ratings (e.g., Motion Picture Association of America (MPAA) ratings), and/or the like), times of transmission, times of availability, bearer indications (e.g., FM radio, IP, MBMS, and/or the like), access information (e.g., radio frequencies, channels, network addresses (e.g., multicast IP addresses), and/or the like), fee information (e.g., a price that would need to be paid for use, receipt, and/or the like of a program), recommendations (e.g., critical reviews, ratings, and/or the like), format information (e.g., indication of available resolutions, bit rates, quality levels, and/or the like), service identifiers, content types (e.g., news, sport, and/or fashion), and/or the like.

The information could be provided in a number of forms. For example, in various embodiments, eXtensible Markup Language (XML), one or more existing program information formats (e.g., Radio Data System (RDS), Radio Broadcast Data System (RBDS), and/or the like), and/or the like might be employed. It is noted that, in various embodiments, data for use by built-in media guides (e.g., for a cable television set-top box) might be employed.

A device receiving the data (step 103) might, in various embodiments, perform one or more operations with respect to the data. For example, the device might act to store some or all of the data, interpret some or all of the data, combine some or all of the data, organize some or all of the data (e.g., organize available programs according to schedule, type, title, genre, bearer, and/or the like), and/or the like. For example, the device, in various embodiments, might act to perform one or more operations with respect to received data so as to facilitate, for instance, UPG provision that allows a user to search for available content via a plurality of parameters, keywords, and/or the like, to provide parameters regarding presentation of information regarding available programs, and/or the like.

In various embodiments, as an alterative to and/or in addition to receiving data of the sort discussed above, a device might receive data, corresponding, for instance, to the program offerings of one or more bearers, produced, compiled, and/or the like by another device (step 105), and/or might act to produce, compile, and/or the like data for use by one or more other devices. Accordingly, for example, in various embodiments one or more servers and/or the like might act to dispatch such produced, compiled, and/or the like data.

Such production, compilation, and/or the like could be performed in a number of ways. For example, a device might perform one or more of the operations discussed above, and make the result of such operations available to other devices (e.g., in one or more of the ways discussed above).

It is noted that, in various embodiments, a device might receive various updates corresponding to received data of the sort discussed above not produced, compiled, and/or the like by another device, corresponding to data produced, compiled, and/or the like by another device, corresponding to the results of one or more operations of the sort discussed above, and/or like.

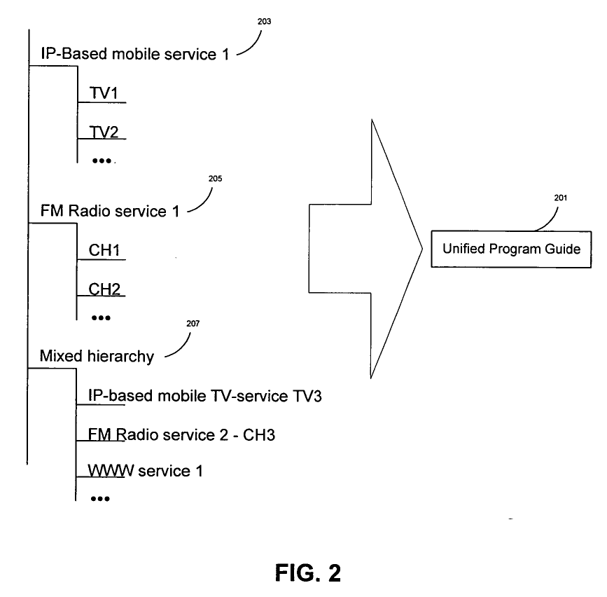

It is further noted that, in various embodiments, UPGs may be able to support various hierarchies (e.g., service hierarchies, session hierarchies, and/or the like). Depicted in FIG. 2 is an exemplary embodiment wherein “Unified Program Guide” 201 relates to “IP-Based mobile service 1” 203, “FM Radio service 1” 205, and “Mixed hierarchy” 207.

Unified Program Guide Operation

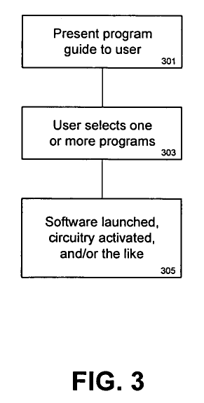

With respect to FIG. 3 it is noted that, using, for instance, received data of the sort discussed above not produced, compiled, and/or the like by another device, data produced, compiled, and/or the like by another device (e.g., a server), the results of one or more operations of the sort discussed above, updates, and/or like, a device, in various embodiments, may act to present a UPG to its user (step 301). For example, a device might act to present its user with a UPG based on operations of the sort discussed above that it had performed, based on data produced, compiled, and/or the like by another device (e.g., a server), or based on a combination of both.

For example, a device may present a Graphical User Interface (GUI), grid, other interface, and/or the like to its user, and make various functionality available to its user via the GUI, grid, other interface, and/or the like. The device could, for instance, implement functionality whereby its user could be able to view a display showing, perhaps for one or more particular times, ranges of time, and/or the like, information regarding the program offerings of one or more bearers. Displayed information for such program offerings might, in various embodiments, include various of the information, data, and/or the like discussed above. For instance, titles, times, genres, types, bearers, service identifiers, metadata, and/or the like might be shown.

In various embodiments, where information regarding the offerings of a plurality of bearers was displayed, display might present multiple sections, with each section corresponding to one or more bearers, one or more groups of bearers, and/or the like. For instance, programs available via FM radio might be shown in one section, programs available via IP might be shown in a second section, and programs available via conventional television might be shown in a third section. In various embodiments, in addition to or as an alterative to such sections, icons, indicators, and/or the like might be employed to indicate the one or more bearers offering a particular program.

In various embodiments, a user might be able to learn of available programs, with corresponding presentation grouping available programs by type, genre, and/or the like. For example, all television programs might be grouped together, all radio programs might be grouped together, and/or the like via a GUI, grid, other interface, and/or the like provided by a device, regardless of the particular bearers being employed in the dispatch of those programs. Accordingly, for example, all radio programs might be grouped together even though some were being made available via DRM, some were being made available via FM radio, some were being made available via satellite radio, some were being made available via IP, and/or the like.

It is noted that, in various embodiments, a user might be able to specify one or more bearers (e.g., via a GUI and/or other interface), and receive (e.g., via a GUI, grid, other interface, and/or the like) information regarding the programs, perhaps for one or more perhaps specified time periods, available via those one or more bearers.

As another example, a user might be able to learn of the one or more bearers making available one or more particular programs. For instance, the user might receive from a device display indicating that a particular audio program was available via a plurality of bearers (e.g., DRM, AM radio, and IP).

In various embodiments, a user might be able to search among available programs. For example, the user could, perhaps via a provided GUI and/or other interface, specify one or more keywords, metadata parameters, names (e.g., service names and/or program names), program types, times, other information, bearers, wildcards, and/or the like. In response, the user could receive from a device, perhaps via a GUI and/or other interface, indication of programs matching the provided criteria. Provision of such functionality could, in various embodiments, make use of data produced, compiled, and/or the like in a manner discussed above.

It is noted that, in various embodiments, functionality could be provided whereby a user could employ a device to select one or more programs for consumption, recording, reception, presentation, display, and/or the like (step 303). Accordingly, for example, the user might be able to employ a GUI and/or other interface provided by the device to select one or more programs presented as being available.

Responsive to such a selection various actions could, perhaps in accordance with a specified time that a selected program would be available, be performed by the device. For example, appropriate software (e.g., viewing software) might be launched, appropriate circuitry (e.g., radio and/or television tuners) might be activated, and/or the like (step 305). A provided UPG might, in various embodiments, make available (e.g., to software, circuitry, and/or the like) information employable, for instance, in corresponding operations (e.g., program reception, presentation, display, and/or the like). For example, a UPG might provide information regarding radio frequencies, channels, network addresses (e.g., IP multicast addressees), and/or the like.

It is noted that, in various embodiments, consumption, recording, reception, presentation, display, and/or the like of programs could occur using standalone functionality (e.g., using standalone software, circuitry, and/or the like), using the UPG (e.g., using an integrated presentation window, perhaps controlled by software, circuitry, and/or the like), and/or using a combination of both.

It is further noted that, in various embodiments, a user might, for example, be able to store in a device various data corresponding to various bearers, program sources, and/or the like. For instance, a user might be able to store in her device data for a number of FM radio stations (e.g., station names, call signs, frequencies, genres, and/or the like).

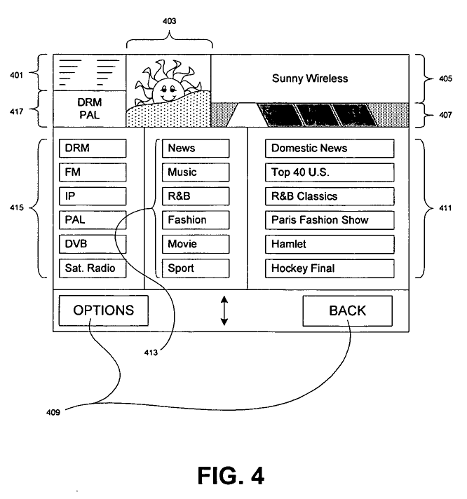

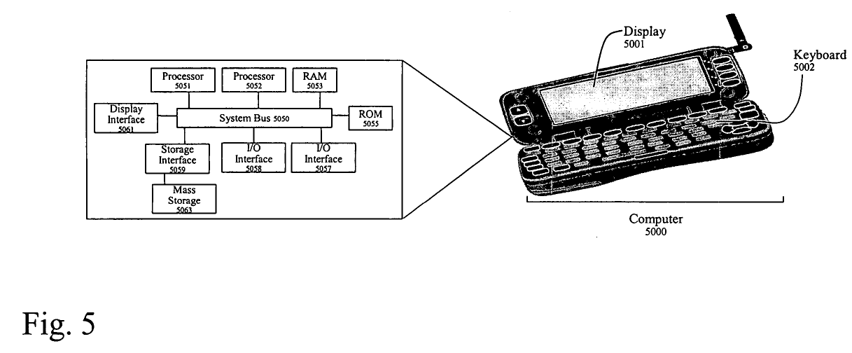

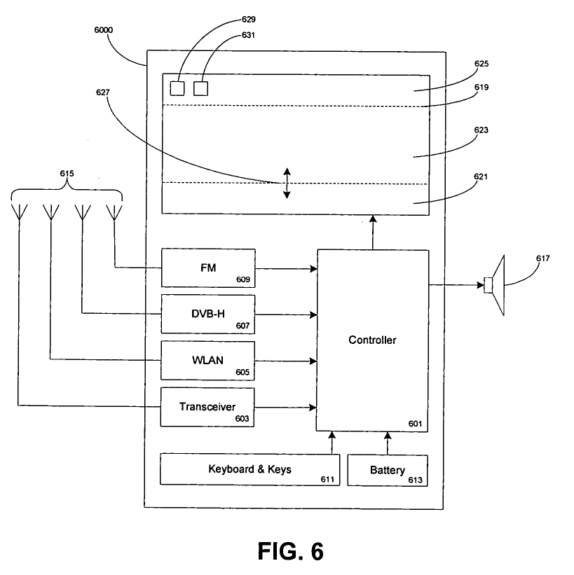

Shown in FIG. 4 in an exemplary GUI according to various embodiments of the present invention. Such a GUI might, for example, be employed by the exemplary computer of FIG. 5, the exemplary computer of FIG. 6, and/or the like. It is noted that although various aspects are shown in this exemplary GUI, some, all, or none of this aspects, and/or variations thereof, may be employed in various embodiments.

Shown in the exemplary GUI of FIG. 4 are signal strength indictors, icons, and/or the like 401 (e.g., conveying one or more signal strengths corresponding to one or more bearers actively employed in program reception, consumption, and/or the like), operator logo 403, operator name 405, tab widgets 407 (e.g., for selecting further descriptions for a corresponding item), soft keys 409 (e.g., providing labels for device buttons), available program titles 411, type, genre, and/or the like icons, indicators, and/or the like 413, bearer type icons, indicators, and/or the like 415, and active bearer icons, indicators, and/or the like 417 (e.g., conveying one or more bearers actively employed in program reception, consumption, and/or the like). In various embodiments, one or more indicators, icons, and/or the like might be employed to convey one or more programs as being received, consumed, and/or the like. Such indicators, icons, and/or the like might, for instance, be applied with respect to icons, indicators, and/or the like 411 whereby it could, for example, be conveyed that one or more available programs were actively being received, consumed, and/or the like.

It is noted that, although various numbers of various aspects are shown in this example, in various embodiments less or more may be shown. It is further noted that, in various embodiments, display to a user might, for example, include a video display area, a messaging areas, a status area, status icons, and/or the like. Various of such aspects might, perhaps, be adjustable. For instance, a user might be able to (perhaps via a GUI and/or other interface) turn on or off, adjust the size of, and/or the like the status area, video display area, messaging area, and/or the like.

Hardware and Software

Various operations and/or the like described herein may be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, node, and/or the like, a server, a network access point, a network multicast point, a network device, a set-top box, a personal video recorder (PVR), a radio (e.g., a digital radio), a television (e.g., a digital television), a game console, or the like, perhaps running an operating system such as OS X, Linux, Darwin, Windows CE, Windows XP, Windows Server 2003, Palm OS, Symbian OS, or the like, perhaps employing the Series 40 Platform, Series 60 Platform, and/or Series 90 Platform, and perhaps having support for Java and/or .Net.

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 5000 as shown in FIG. 5 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, wireless universal serial bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Audio Broadcast (DAB), satellite radio, Digital Radio Mondial (DRM), Digital Audio Broadcasting (DAB), amplitude modulation (AM) radio, frequency modulation (FM) radio, satellite television, digital cable television, Phase Alternating Line (PAL) television, National Television Standards Committee (NTSC) television, General Packet Radio Service (GPRS), Universal Mobile Telecommunications Service (UMTS), Global System for Mobile Communications (GSM), DVB-H (Digital Video Broadcasting: Handhelds), IrDA (Infrared Data Association), and/or other interface.

Mass storage 5063 may be a hard drive, optical drive, flash memory, or the like. Mass storage 5063 might be removable. Processors 5051 and 5052 may each be a commonly known processor such as an IBM or Motorola PowerPC, an AMD Athlon, an AMD Opteron, an Intel ARM, an Intel XScale, a Transmeta Crusoe, a Transmeta Efficeon, an Intel Xenon, an Intel Itanium, or an Intel Pentium. Computer 4000 as shown in this example also includes a touch screen 5001 and a keyboard 5002. In various embodiments, a non-touch screen might alternately or additionally be employed. It is further noted that, in various embodiments, a mouse, a keypad, device buttons (e.g., for use as soft keys), multiposition selector switches (e.g., a joystick), and/or other interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, and/or Xen according to methods known in the art. Corresponding program code might be placed on media such as, for example, DVD, CD-ROM, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed.

Shown in FIG. 6 is a diagram of a device, an exemplary computer employable in various embodiments of the present invention. Exemplary device 6000 of FIG. 6 comprises controller 601 (including, for example, processor and memory, the memory perhaps containing data and/or executable code), transceiver 603 (e.g., for GSM, GPRS, UMTS, and/or the like), wireless local area network (WLAN) interface 605 (e.g., IEEE 802.11a, IEEE 802.11b, and/or IEEE 802.11g), DVB-H interface 607, FM interface 609, keyboard and keys 611 (device buttons (e.g., for use as soft keys), multiposition selector switches (e.g., a joystick), and/or the like might be employed in various embodiments), battery 613, antennas 615, audio output 617, and display 619. Shown in conjunction with display 619 are messaging area 621, video display area 623, status area 625, messaging-video display area size control 627, and status icons 629 and 631. Also provided, in various embodiments, may be a speaker for producing audio signals, with voice recognition perhaps being provided for.

Controller 601 may, in various embodiments, control, perhaps on the basis of software, operation of device 6000, such as, for instance, receiving of a data stream, tolerance of impulse burst noise in data reception, displaying user interface output, and/or reading user interface input.

Circuitry for detecting signal, circuitry for demodulation, circuitry for detecting impulse, circuitry for blanking those samples of the symbol where significant amount of impulse noise is present, circuitry for calculating estimates, and/or circuitry for performing the corrections of the corrupted data may, in various embodiments, be included. Alternately or additionally, middleware and/or other software might be employed.

Device 6000 can, for instance, be a hand-held device which a user can comfortably carry. Device 6000 may possibly interact with service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

1. A method, comprising:
receiving program information for one or more programs; and
providing a unified program guide, wherein the unified program guide corresponds to at least some of the received program information,
wherein the unified program guide indicates, for each of a plurality of bearer types, one or more programs being offered, and
wherein one or more of the bearer types are not general purpose data bearer types.

2. The method of claim 1, further comprising providing for selection of one or more programs via the unified program guide.

3. The method of claim 1, further comprising providing for consumption of one or more programs.

4. The method of claim 1, wherein the program guide provides information for launching software for consumption of an available program.

5. The method of claim 1, wherein the program guide provides information for activating circuitry for consumption of an available program.

6. The method of claim 1, further comprising providing for program search via the unified program guide.

7. The method of claim 1, wherein the plurality of bearer types includes internet protocol.

8. The method of claim 1, wherein the plurality of bearer types includes general packet radio service.

9. The method of claim 1, wherein the plurality of bearer types includes universal mobile telecommunications service.

10. The method of claim 1, wherein the plurality of bearer types includes bluetooth.

11. The method of claim 1, wherein the plurality of bearer types includes IEEE 802.11.

12. The method of claim 1, wherein the bearer types that are not general purpose data bearer types comprise frequency modulation radio.

13. The method of claim 1, wherein the bearer types that are not general purpose data bearer types comprise digital audio broadcasting.

14. The method of claim 1, wherein the bearer types that are not general purpose data bearer types comprise digital radio mondial.

15. The method of claim 1, wherein the bearer types that are not general purpose data bearer types comprise digital video broadcasting.

16. A method, comprising:
receiving, at a first device, program information for one or more programs;
compiling, at the first device, unified program guide data, wherein compilation at the first device employs at least some of the program information received at the first device; and
dispatching, from the first device, the unified program guide data compiled at the first device,
wherein a unified program guide is provided at a second device, wherein the second device receives the unified program guide data compiled at the first device,
wherein the unified program guide indicates, for each of a plurality of bearer types, one or more programs being offered, and
wherein one or more of the bearer types are not general purpose data bearer types.

17. The method of claim 16, wherein the second device compiles unified program guide data.

18. The method of claim 17, wherein compilation at the second device employs at least some of program information, corresponding to one or more programs, received at the second device.

19. The method of claim 16, wherein the unified program guide makes use of at least some of the unified program guide data compiled at the first device and at least some unified program guide data compiled at the second device.

20. The method of claim 16, wherein the second device receives program information for one or more programs.

21. The method of claim 16, wherein the unified program guide provides for selection of one or more programs.

22. The method of claim 16, wherein consumption of one or more programs is provided for.

23. The method of claim 16, wherein the unified program guide provides information for launching software for consumption of an available program.

24. The method of claim 16, wherein the unified program guide provides information for activating circuitry for consumption of an available program.

25. The method of claim 16, wherein the unified program guide provides for program search.

26. The method of claim 16, wherein the plurality of bearer types includes internet protocol.

27. The method of claim 16 wherein the plurality of bearer types includes general packet radio service.

28. The method of claim 16, wherein the plurality of bearer types includes universal mobile telecommunications service.

29. The method of claim 16, wherein the plurality of bearer types includes bluetooth.

30. The method of claim 16, wherein the plurality of bearer types includes IEEE 802.11.

31. The method of claim 16, wherein the bearer types that are not general purpose data bearer types comprise frequency modulation radio.

32. The method of claim 16, wherein the bearer types that are not general purpose data bearer types comprise digital audio broadcasting.

33. The method of claim 16, wherein the bearer types that are not general purpose data bearer types comprise digital radio mondial.

34. The method of claim 16, wherein the bearer types that are not general purpose data bearer types comprise digital video broadcasting.

35. A system, comprising:
a memory having program code stored therein; and
a processor disposed in communication with the memory for carrying out instructions in accordance with the stored program code;
wherein the program code, when executed by the processor, causes the processor to perform:
receiving program information for one or more programs; and
providing a unified program guide, wherein the unified program guide corresponds to at least some of the received program information,
wherein the unified program guide indicates, for each of a plurality of bearer types, one or more programs being offered, and
wherein one or more of the bearer types are not general purpose data bearer types.

36. The system of claim 35, wherein the processor further performs providing for selection of one or more programs via the unified program guide.

37. The system of claim 35, wherein the processor further performs providing for consumption of one or more programs.

38. The system of claim 35, wherein the program guide provides information for launching software for consumption of an available program.

39. The system of claim 35, wherein the program guide provides information for activating circuitry for consumption of an available program.

40. The system of claim 35, wherein the processor further performs providing for program search via the unified program guide.

41. The system of claim 35, wherein the plurality of bearer types includes internet protocol.

42. The system of claim 35, wherein the plurality of bearer types includes general packet radio service.

43. The system of claim 35, wherein the plurality of bearer types includes universal mobile telecommunications service.

44. The system of claim 35, wherein the plurality of bearer types includes bluetooth.

45. The system of claim 35, wherein the plurality of bearer types includes IEEE 802.11.

46. The system of claim 35, wherein the bearer types that are not general purpose data bearer types comprise frequency modulation radio.

47. The system of claim 35, wherein the bearer types that are not general purpose data bearer types comprise digital audio broadcasting.

48. The system of claim 35, wherein the bearer types that are not general purpose data bearer types comprise digital radio mondial.

49. The system of claim 35, wherein the bearer types that are not general purpose data bearer types comprise digital video broadcasting.

50. A system, comprising:
a memory having program code stored therein; and
a processor disposed in communication with the memory for carrying out instructions in accordance with the stored program code;
wherein the program code, when executed by the processor, causes the processor to perform:
receiving, at a first device, program information for one or more programs;
compiling, at the first device, unified program guide data, wherein compilation at the first device employs at least some of the program information received at the first device; and
dispatching, from the first device, the unified program guide data compiled at the first device,
wherein a unified program guide is provided at a second device, wherein the second device receives the unified program guide data compiled at the first device,
wherein the unified program guide indicates, for each of a plurality of bearer types, one or more programs being offered, and
wherein one or more of the bearer types are not general purpose data bearer types.

51. The system of claim 50, wherein the second device compiles unified program guide data.

52. The system of claim 51, wherein compilation at the second device employs at least some of program information, corresponding to one or more programs, received at the second device.

53. The system of claim 50, wherein the unified program guide makes use of at least some of the unified program guide data compiled at the first device and at least some unified program guide data compiled at the second device.

54. The system of claim 50, wherein the second device receives program information for one or more programs.

55. The system of claim 50, wherein the unified program guide provides for selection of one or more programs.

56. The system of claim 50, wherein consumption of one or more programs is provided for.

57. The system of claim 50, wherein the unified program guide provides information for launching software for consumption of an available program.

58. The system of claim 50, wherein the unified program guide provides information for activating circuitry for consumption of an available program.

59. The system of claim 50, wherein the unified program guide provides for program search.

60. The system of claim 50, wherein the plurality of bearer types includes internet protocol.

61. The system of claim 50 wherein the plurality of bearer types includes general packet radio service.

62. The system of claim 50, wherein the plurality of bearer types includes universal mobile telecommunications service.

63. The system of claim 50, wherein the plurality of bearer types includes bluetooth.

64. The system of claim 50, wherein the plurality of bearer types includes IEEE 802.11.

65. The system of claim 50, wherein the bearer types that are not general purpose data bearer types comprise frequency modulation radio.

66. The system of claim 50, wherein the bearer types that are not general purpose data bearer types comprise digital audio broadcasting.

67. The system of claim 50, wherein the bearer types that are not general purpose data bearer types comprise digital radio mondial.

68. The system of claim 50, wherein the bearer types that are not general purpose data bearer types comprise digital video broadcasting.

69. A method, comprising:
providing one or more user interface elements informing a user of one or more available programs; and
providing one or more user interface elements informing the user of one or more bearer types involved in dispatch of one or more of the available programs,
wherein one or more of the bearer types are not general purpose data bearer types.

70. The method of claim 69, wherein multiple sections are displayed to the user, and wherein each section corresponds to one or more bearer types.

71. The method of claim 69, further comprising providing one or more user interface elements informing the user, for each of one or more of the available programs, of one or more corresponding genres.

72. The method of claim 69, further comprising providing one or more user interface elements informing the user, for each of one or more of the available programs, of one or more corresponding types

73. The method of claim 69, further comprising providing one or more user interface elements informing the user of one or more bearer types being employed in program reception.

74. The method of claim 69, further comprising providing one or more user interface elements informing the user of one or more programs being received.

75. The method of claim 69, wherein the user is informed of one or more program titles.

76. The method of claim 69, further comprising providing one or more user interface elements informing the user of one or more signal strengths corresponding to one or more bearer types being employed in program reception.

77. The method of claim 69, wherein one or more icons are employed.

78. The method of claim 69, further comprising providing one or more user interface elements employable in program search.

79. A network device, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
receiving program information for one or more programs;
compiling unified program guide data, wherein compilation employs at least some of the received program information; and
making available the compiled unified program guide data to one or more devices,
wherein the compiled unified program guide data corresponds to a plurality of bearer types, and
wherein the compiled unified program guide data comprises data corresponding to one or more programs available via frequency modulation radio.

80. A terminal, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
providing a unified program guide,
wherein the unified program guide corresponds to a plurality of bearer types, and
wherein the unified program guide indicates one or more programs available via frequency modulation radio.
